(19) United States
(12) Patent Application Publication
(10) Pub. No.: US 2025/0332767 A1
(43) Pub. Date: Oct. 30, 2025

(54) EPS PRODUCT HAVING WATER REPELLENCY, EPS PRODUCT MOLD, AND METHOD FOR MANUFACTURING EPS PRODUCT

(71) Applicant: SAMSUNG ELECTRONICS CO., LTD., Suwon-si (KR)

(72) Inventors: Donghun Lee, Suwon-si (KR); Eunho Moon, Suwon-si (KR); Jaehoon Choi, Suwon-si (KR)

(73) Assignee: SAMSUNG ELECTRONICS CO., LTD., Suwon-si (KR)

(21) Appl. No.: 19/262,928

(22) Filed: Jul. 8, 2025

Related U.S. Application Data
(63) Continuation of application No. PCT/KR2023/021429, filed on Dec. 22, 2023.

(30) Foreign Application Priority Data
Jan. 16, 2023 (KR) 10-2023-0006334

(51) Int. Cl. B29C 44/04; B29C 44/34; B29C 44/58; B29K 25/00; B29K 105/04; B29L 31/00; B32B 27/08; B32B 27/30

(52) U.S. Cl. CPC B29C 44/0407; B29C 44/3426; B29C 44/58; B32B 27/08; B32B 27/302; B29K 2025/06; B29K 2105/04; B29K 2995/0063; B29K 2995/0097; B29L 2031/7622; B32B 2250/02; B32B 2250/246; B32B 2266/0228; B32B 2307/72; B32B 2307/7376; B32B 2509/10

(57) ABSTRACT

An expanded polystyrene (EPS) product includes an EPS body; and a polystyrene layer on a portion of a surface of the EPS body, wherein a density of the polystyrene layer is greater than a density of the EPS body, and both the EPS body and the polystyrene layer include EPS.

### CROSS-REFERENCE TO RELATED APPLICATIONS

This application is a continuation of International Application No. PCT/KR2023/021429, filed on Dec. 22, 2023, which is based on and claims priority to Korean Patent Application No. 10-2023-0006334, filed on Jan. 16, 2023, in the Korean Intellectual Property Office, the disclosures of which are incorporated by reference herein in their entireties.

### BACKGROUND

### 1. Field

The disclosure relates to an expanded polystyrene (EPS) product having waterproof properties, an EPS product mold for manufacturing the EPS product, and a method for manufacturing the EPS product.

### 2. Description of Related Art

Generally, a refrigerator may include a storage compartment and a refrigeration cycle device capable of maintaining the storage compartment at a low temperature to enable storage of food at the low temperature.

The refrigeration cycle device may include a compressor, a condenser, an expansion valve, and an evaporator.

The evaporator may be installed adjacent to the storage compartment and may cool air in the storage compartment. For example, a fan may be used to allow air in the storage compartment to pass through the evaporator and then be discharged back into the storage compartment. Then, the temperature of the storage compartment may be maintained low.

For example, the evaporator may be installed at the rear side of the storage compartment, and a cold air duct through which cold air passes may be provided between the storage compartment and the evaporator.

For example, the cold air duct may be manufactured by molding expanded polystyrene (EPS). Hereinafter, a product manufactured from expanded polystyrene is referred to as an expanded polystyrene product (hereinafter, referred to as an EPS product).

EPS products are white, lightweight, and have excellent water resistance, heat insulation, soundproofing, and cushioning properties, so they are used in home appliances such as refrigerators.

### SUMMARY

Provided is an EPS product having waterproof properties.

Further, provided is an EPS product mold used to manufacture an EPS product having waterproof properties.

Further still, provided is a method for manufacturing an EPS product having waterproof properties.

According to an aspect of the disclosure, an expanded polystyrene (EPS) product includes: an EPS body; and a polystyrene layer on a portion of a surface of the EPS body, wherein a density of the polystyrene layer is greater than a density of the EPS body, and both the EPS body and the polystyrene layer include EPS.

The EPS body may be under the polystyrene layer, and the polystyrene layer and the EPS body may be formed together in a same mold.

A density of the EPS body may be 0.03 to 0.05 of the density of the polystyrene layer.

A thickness of the polystyrene layer may be thinner than a thickness of the EPS body.

According to an aspect of the disclosure, an EPS product mold includes: an upper mold including an upper core; a lower mold including a lower core configured to fit to the upper core and thereby form a cavity corresponding to an EPS product; a heating core provided in the upper core and configured to form a polystyrene layer on the EPS product; and a resin replenishment device provided at least partly in the lower core and configured to form a replenishment resin space in which replenishment resin is received within the cavity.

The resin replenishment device may face the heating core.

The resin replenishment device may include: an extension wall extending from the lower core and including a side surface of the replenishment resin space; a moving plate installed on an inside of the extension wall and facing inside of the cavity, the moving plate including a lower surface of the replenishment resin space; and a moving device configured to move the moving plate up and down with respect to the extension wall.

The moving device may be further configured to move the moving plate with respect to the extension wall at least to a position at which an upper surface of the moving plate coincides with the lower surface of the lower core.

The heating core may include an induction coil.

The EPS product mold may further include a steam generator configured to supply steam heating the upper core and the lower core, and the upper mold and the lower mold may be connected to the steam generator.

A temperature of the heating core may be higher than temperatures of the upper core and the lower core heated by the steam.

The EPS product mold may further include a cooling device configured to cool the upper core and the lower core.

According to an aspect of the disclosure, a method for manufacturing an EPS product, includes: heating a heating core; moving an upper mold to be adjacent to a lower mold to form a resin filling space by an upper core of the upper mold and a lower core of the lower mold; filling resin into the resin filling space; moving the upper mold so that the upper core and the lower core together form a cavity corresponding to the EPS product; heating the upper core and the lower core by supplying steam to at least one of the upper mold or the lower mold; operating a resin replenishment device to supply a resin into the cavity and replenish a molten volume of the resin; terminating the heating of the heating core; terminating the supplying of the steam; operating a cooling device to cool the upper core and the lower core; moving the upper mold away from the lower mold; and taking out the EPS product from the lower core.

At least some of the resin may contact the heating core and forms a polystyrene layer of the EPS product.

A volume of the resin filling space may correspond to an amount of the resin forming the polystyrene layer.

### BRIEF DESCRIPTION OF DRAWINGS

The above and/or other aspects, features, and advantages of certain embodiments of the disclosure will be more apparent from the following description taken in conjunction with the accompanying drawings, in which:

FIG. 1 is a perspective view illustrating an EPS product according to one or more embodiments of the disclosure;

FIG. 2 is a cross-sectional view illustrating the EPS product of FIG. 1 taken along line A-A;

FIG. 3 is an enlarged cross-sectional view illustrating part A of the EPS product of FIG. 2;

FIG. 4 is a perspective view illustrating an EPS product mold for manufacturing an EPS product according to one or more embodiments of the disclosure;

FIG. 5 is a cross-sectional view illustrating the EPS product mold of FIG. 4 cut;

FIG. 6 is a perspective view illustrating an upper core of the EPS product mold of FIG. 4;

FIG. 7 is a rear perspective view illustrating the upper core of FIG. 6;

FIG. 8 is an exploded perspective view illustrating the upper core of FIG. 7;

FIG. 9 is a perspective view illustrating a lower mold of the EPS product mold of FIG. 4.;

FIG. 10A is a cross-sectional view illustrating a state in which an upper mold and a lower mold of an EPS product mold according to one or more embodiments of the disclosure are spaced apart from each other;

FIG. 10B is a cross-sectional view illustrating a state in which the upper mold is lowered in FIG. 10A and an upper core is inserted into a lower core of the lower mold;

FIG. 10C is a cross-sectional view illustrating a state in which the upper core of the upper mold is completely inserted into the lower core of the lower mold to form a cavity in FIG. 10B;

FIG. 10D is a cross-sectional view illustrating a state in which a resin replenishment device is raised in FIG. 10C;

FIG. 10E is a cross-sectional view illustrating a state in which the upper core and the lower core are cooled in FIG. 10D;

FIG. 10F is a cross-sectional view illustrating a state in which the upper mold is raised in FIG. 10E and an EPS product is taken out;

FIG. 11 is a graph comparing the moisture permeability of an EPS product according to one or more embodiments of the disclosure and the moisture permeability of an EPS product according to a comparative example;

FIG. 12 is a perspective view illustrating a cold air duct using an EPS product 100 according to one or more embodiments of the disclosure;

FIG. 13 is an exploded perspective view illustrating the cold air duct of FIG. 12; and

FIG. 14 is a perspective view illustrating a refrigerator using an EPS product 100 according to one or more embodiments of the disclosure.

### DETAILED DESCRIPTION

Since the embodiments of the disclosure can apply various transformations and have various embodiments, specific embodiments will be illustrated in the drawings and described in detail in the detailed description. However, this is not intended to limit the scope to the specific embodiments, and should be understood to include various modifications, equivalents, and/or alternatives of the embodiment of the disclosure. In connection with the description of the drawings, like reference numerals may be used for like elements.

In describing the disclosure, when it is determined that a detailed description of a related known function or configuration may unnecessarily obscure the gist of the disclosure, a detailed description thereof will be omitted.

In addition, the following embodiments may be modified in many different forms, and the scope of the technical idea of the disclosure is not limited to the following embodiments. Rather, these embodiments are provided so that this disclosure will be thorough and complete, and will fully convey the spirit of the disclosure to those skilled in the art.

Terms used in this disclosure are only used to describe specific embodiments, and are not intended to limit the scope of rights. Singular expressions include plural expressions unless the context clearly dictates otherwise.

In this disclosure, expressions such as “has,” “can have”, “includes,” or “can include” indicate the existence of a corresponding feature (e.g., numerical value, function, operation, or component such as a part) and do not preclude the existence of additional features.

As used herein, expressions such as “at least one of,” when preceding a list of elements, modify the entire list of elements and do not modify the individual elements of the list. For example, the expression, “at least one of A or b,” should be understood as including only A, only B, or both A and B.

Expressions such as “first,” “second,” “primary,” or “secondary,” as used in this disclosure may modify various components regardless of order and/or importance, are used only to distinguish one component from other components, and do not limit the corresponding components.

Further, terms such as ‘leading end’, ‘rear end’, ‘upper side’, ‘lower side’, ‘top end’, ‘bottom end’, etc. used in the disclosure are defined with reference to the drawings. However, the shape and position of each component are not limited by these terms.

Hereinafter, embodiments of an EPS product 100 according to the disclosure will be described in detail with reference to the attached drawings.

In the following descriptions, the EPS product 100 refers to a product made of expanded polystyrene.

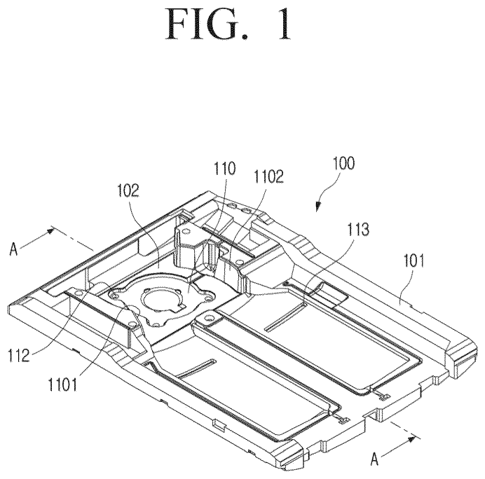

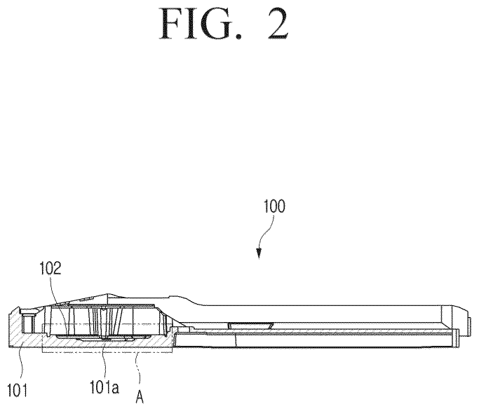

FIG. 1 is a perspective view illustrating an EPS product 100 according to one or more embodiments of the disclosure. FIG. 2 is a cross-sectional view illustrating the EPS product 100 of FIG. 1 taken along line A-A.

Referring to FIG. 1 and FIG. 2, an EPS product 100 according to one or more embodiments of the disclosure may include a body 101 and a polystyrene layer 102.

The body 101 may be formed of expanded polystyrene (EPS). The body 101 may be formed in various shapes depending on the purpose of the EPS product 100.

The polystyrene layer 102 may be formed on a portion of one surface of the body 101. The polystyrene layer 102 may be formed with a dense structure so that moisture may not penetrate inside the polystyrene layer 102. In other words, the polystyrene layer 102 may have waterproof properties.

The density of the polystyrene layer 102 may be greater than the density of the body 101, that is, the EPS. For example, when the density of the polystyrene layer 102 is 1, the density of the EPS body 101 may be 0.03 to 0.05 of the density of the polystyrene layer 102.

The polystyrene layer 102 and the body 101 may both be formed of expanded polystyrene. The polystyrene layer 102 and the body 101 may be formed simultaneously in a single mold, and the molding temperature of the polystyrene layer 102 may be higher than the molding temperature of the body 101. For example, the molding temperature of the polystyrene layer 102 may be in a range of about 100° C. to about 120° C., and the molding temperature of the body 101 may be about 90° C.

The thickness of the polystyrene layer 102 may be thinner than the thickness of a layer formed of EPS located below the polystyrene layer 102, that is, an EPS layer of the body 101. For example, the thickness of the polystyrene layer 102 may be 1 mm to 2 mm, and the thickness of the EPS layer may be 3 mm to 4 mm. When the thickness of the polystyrene layer 102 is 1 mm to 2 mm, moisture may not be prevented from penetrating into the polystyrene layer 102. In other words, the polystyrene layer 102 may have waterproof properties.

A transition zone may be formed between the polystyrene layer 102 and the EPS layer. The transition zone refers to a region where the density changes. In detail, it refers to a region where the density gradually decreases from the high-density polystyrene layer 102 to the low-density EPS layer. The density of the transition zone may gradually decrease from the high-density polystyrene layer 102 to the low-density EPS layer.

The body 101 and the polystyrene layer 102 may both be formed of expanded polystyrene. The body 101 and the polystyrene layer 102 may be integrally formed of expanded polystyrene using an EPS product mold 1. In other words, when molding the EPS product 100 using the EPS product mold 1, the body 101 and the polystyrene layer 102 may be formed simultaneously.

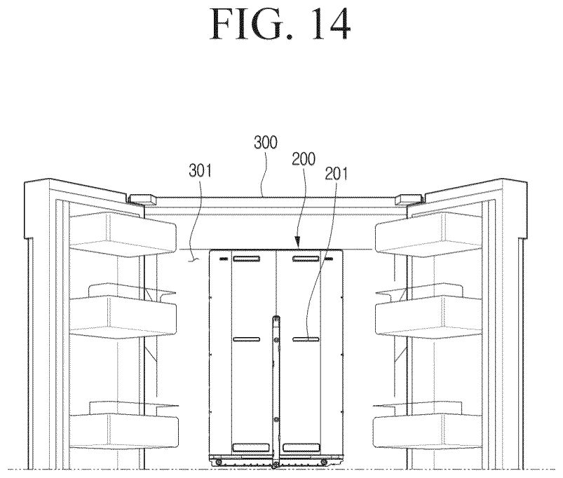

The EPS product 100 according one or more embodiments illustrated in FIG. 1 and FIG. 2 may be an evaporator cover forming a cold air duct 200 of a refrigerator 300 (see FIG. 14). Accordingly, the body 101 may be formed in an approximately flat plate shape.

A fan for sucking air into the evaporator may be installed in the body 101. Accordingly, a fan seat 110 where the fan is installed and a plurality of openings 113 through which air passes may be provided on the upper surface of the body 101. A plurality of fixing holes 112 for fixing the fan may be provided in the fan seat 110.

Air containing moisture may continuously collide with the fan seat 110 where the fan is installed. Therefore, when the fan seat 110 is formed of EPS, moisture may penetrate into the fan seat 110 over time.

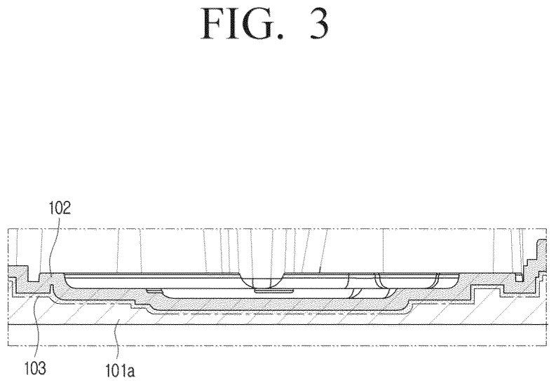

To prevent or minimize this, the EPS product 100 according to one or more embodiments of the disclosure may include a polystyrene layer 102 formed in the fan seat 110 of the body 101. Hereinafter, the polystyrene layer 102 will be described in detail with reference to FIG. 3.

FIG. 3 is an enlarged cross-sectional view illustrating part A of the EPS product 100 of FIG. 2.

The polystyrene layer 102 may be formed on a portion of one surface of the body 101. The polystyrene layer 102 may be formed to have a dense tissue so that moisture may not penetrate.

The density of the polystyrene layer 102 may be greater than the density of the body 101, that is, the EPS. For example, when the density of the polystyrene layer 102 is one (1), the density of the EPS may be 0.03 to 0.05 of the density of the polystyrene layer 102.

The thickness of the polystyrene layer 102 may be thinner than the thickness of a layer formed of EPS, that is, an EPS layer 101a, located below the polystyrene layer 102. For example, the thickness of the polystyrene layer 102 may be 1 to 2 mm, and the thickness of the EPS layer 101a may be 3 to 4 mm. When the thickness of the polystyrene layer 102 is 1 to 2 mm, moisture may be prevented from penetrating into the polystyrene layer 102. In other words, the polystyrene layer 102 may have waterproof properties.

Except for the upper surface of the polystyrene layer 102, the lower surface and the entire perimeter of the polystyrene layer 102 may be surrounded by the EPS. Therefore, the portion of the body 101 where the polystyrene layer 102 is formed may have a two-layer structure. In other words, the lower layer may be the EPS layer 101a, and the upper layer may be the polystyrene layer 102. However, the other portion of the body 101 where the polystyrene layer 102 is not formed may have a single-layer structure. In other words, the entire thickness of the body 101 may be formed entirely of EPS.

A transition zone 103 may be formed between the polystyrene layer 102 and the EPS layer 101a. The transition zone 103 refers to a region where the density changes. In detail, the transition zone 103 refers to a region where the density gradually decreases between the high-density polystyrene layer 102 and the low-density EPS layer 101a. In the transition zone 103, the density may gradually decrease from the polystyrene layer 102 to the EPS layer 101a.

Because the lower surface and the entire perimeter of the polystyrene layer 102 are surrounded by the EPS, the transition zone 103 may be formed on the lower surface and the entire perimeter of the polystyrene layer 102.

As illustrated in FIG. 1, when the fan seat 110 is formed concavely, the polystyrene layer 102 may be formed on the side surface of the fan seat 110. The polystyrene layer 102 on the side surface may be formed in the same manner as the polystyrene layer 102 described above. In the case of the evaporator cover 100 shown in FIG. 1, a left side surface 1101 and a right side surface 1102 of the fan seat 110 may be formed of the polystyrene layer 102.

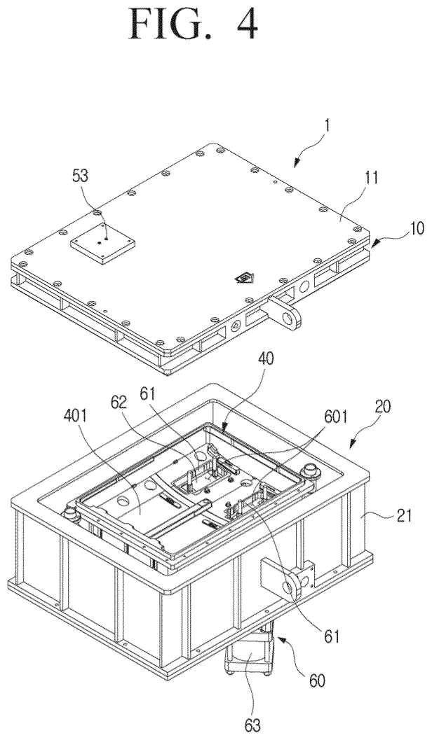

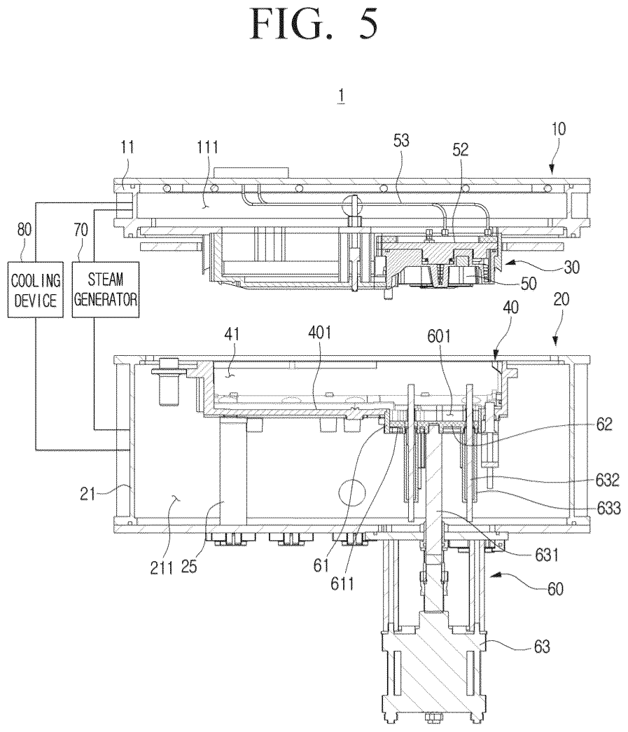

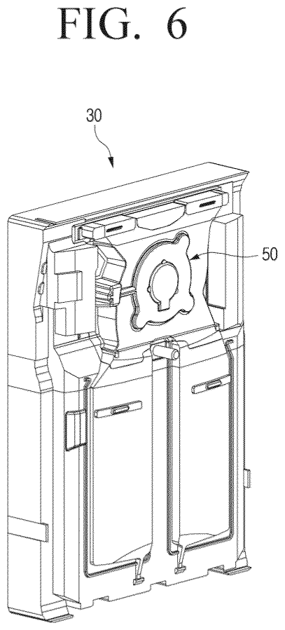

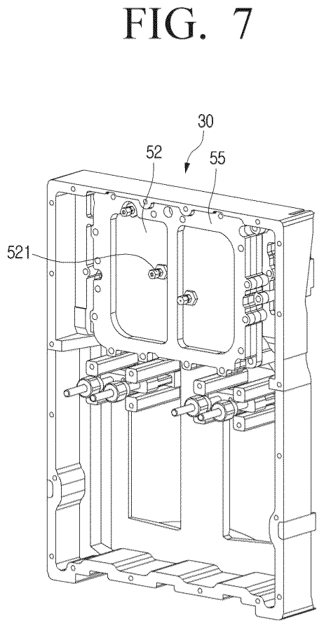

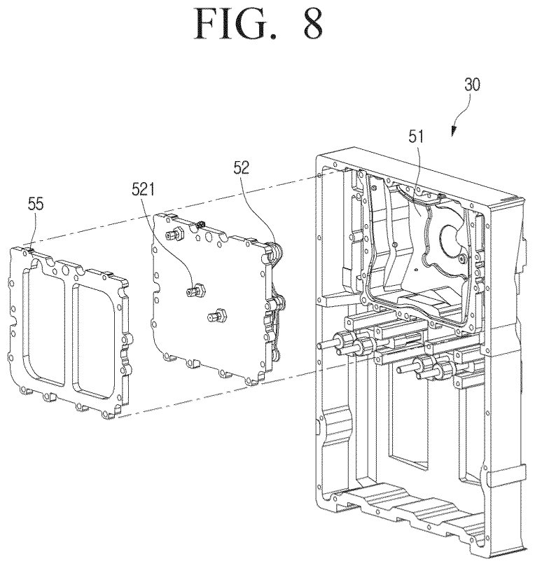

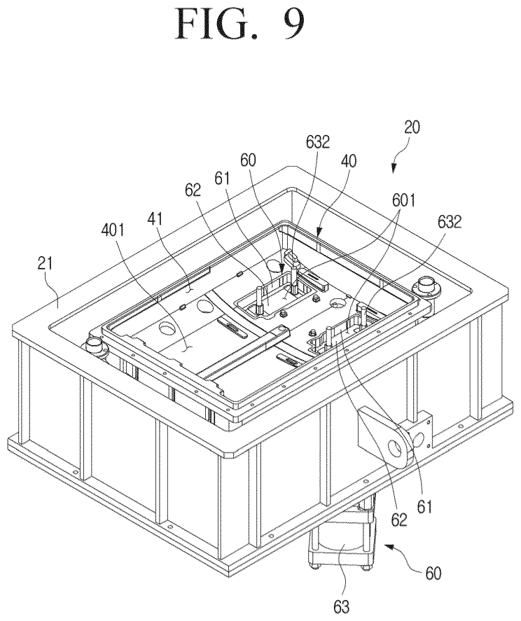

Hereinafter, an EPS product mold 1 according to one or more embodiments of the disclosure will be described in detail with reference to FIG. 4, FIG. 5, FIG. 6, FIG. 7, FIG. 8, and FIG. 9. For reference, in the following description, the EPS product mold 1 includes two molds, an upper mold 10 and a lower mold 20. In FIG. 4 and FIG. 5, a mold located on the upper side is referred as an upper mold 10, and another mold located on the lower side is referred to as a lower mold 20.

FIG. 4 is a perspective view illustrating an EPS product mold 1 for manufacturing an EPS product 100 according to one or more embodiments of the disclosure. FIG. 5 is a cross-sectional view illustrating the EPS product mold 1 of FIG. 4. FIG. 6 is a perspective view illustrating an upper core 30 of the EPS product mold 1 of FIG. 4. FIG. 7 is a rear perspective view illustrating the upper core 30 of FIG. 6. FIG. 8 is an exploded perspective view illustrating the upper core 30 of FIG. 7. FIG. 9 is a perspective view illustrating a lower mold 20 of the EPS product mold 1 of FIG. 4.

Referring to FIG. 4, FIG. 5, FIG. 6, FIG. 7, FIG. 8, and FIG. 9, an EPS product mold 1 according to one or more embodiments of the disclosure may include an upper mold 10 and a lower mold 20.

The upper mold 10 may include an upper core 30. The upper core 30 may be disposed on an upper plate 11. The upper core 30 may be disposed on a lower surface of the upper plate 11. The upper core 30 may be disposed to protrude from the lower surface of the upper plate 11.

The upper core 30 may include a heating core 50. The heating core 50 may be configured to form the polystyrene layer 102 on the EPS product 100.

The heating core 50 may be provided on a portion of the upper core 30. The heating core 50 may be disposed on a portion of the upper core 30 corresponding to a portion of the EPS product 100 where the polystyrene layer 102 is to be formed.

The heating core 50 may be configured in a shape corresponding to the polystyrene layer 102 of the EPS product 100. For example, when molding the EPS product 100 such as FIG. 1, the heating core 50 may be configured in a shape corresponding to the fan seat 110.

The heating core 50 may include a heating source 52. The heating core 50 may be heated a certain temperature by the heating source 52. For example, a high-frequency induction coil may be used as the heating source 52. In this case, the heating core 50 may include a high-frequency induction coil.

Referring to FIG. 7 and FIG. 8, the heating source 52 may be disposed on the rear side of the heating core 50. The rear side of the heating core 50 may be provided with a heating source receiving portion 51 in which the heating source 52 is received. The heating source 52 may be disposed in the heating source receiving portion 51 of the heating core 50.

The heating source 52 may be fixed to the rear side of the upper core 30 by a heating source fixing plate 55.

In the case where a high-frequency induction coil is used as the heating source 52, two connection terminals 521 may be provided on the lower surface of the heating source 52.

The two connection terminals 521 may be connected to the upper surface of the upper plate 11 by two wires 53. An external heating device may be connected to one ends of the two wires 53 exposed to the upper surface of the upper plate 11. For example, a high-frequency generator may be used as the external heating device. Accordingly, when high-frequency power is supplied from the high-frequency generator through the two wires 53, the high-frequency induction coil 52 may generate heat. When heat is generated by the high-frequency induction coil 52, the heating core 50 in contact with the high-frequency induction coil 52 may be heated.

The upper plate 11 may support the upper core 30 and move integrally with the upper core 30. The upper plate 11 may be configured to be mounted on a molding device, for example, an injection molding device, and to move linearly relative to the lower plate 21.

A space may be provided inside the upper plate 11. In other words, an internal space 111 may be provided between the outer surface of the upper plate 11 and the upper core 30. Steam for heating the upper core 30 may be supplied to the internal space 111 of the upper plate 11. In addition, coolant for cooling the upper core 30 may be supplied to the internal space 111 of the upper plate 11.

The two wires 53 installed inside the upper plate 11 may be accommodated in a protective tube so as not to be affected by seam and coolant.

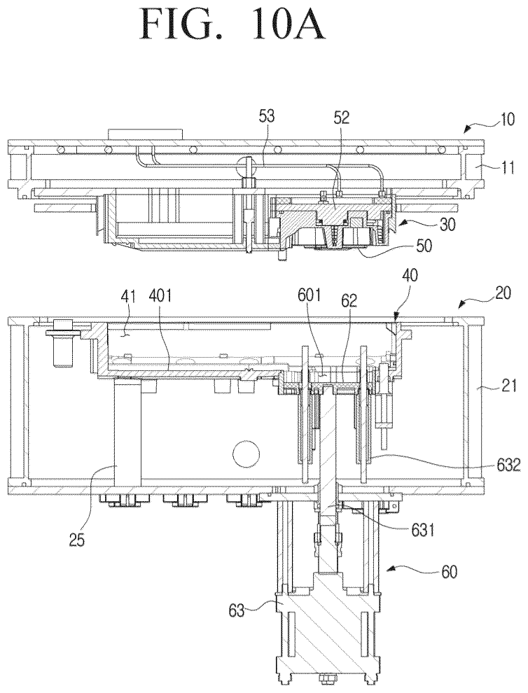

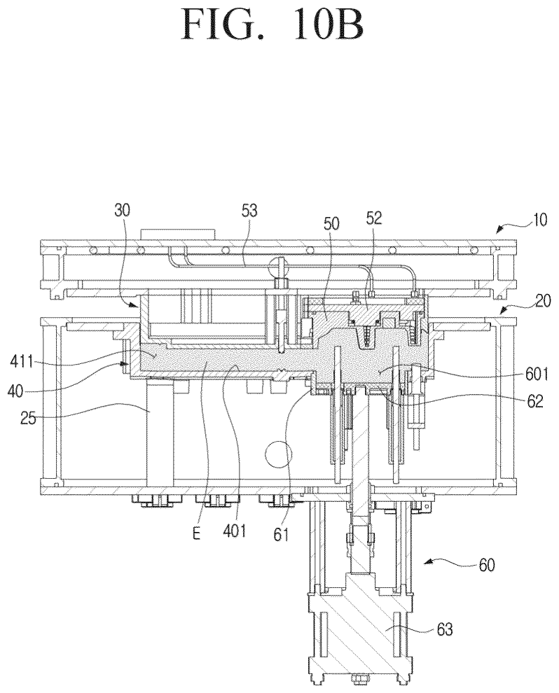

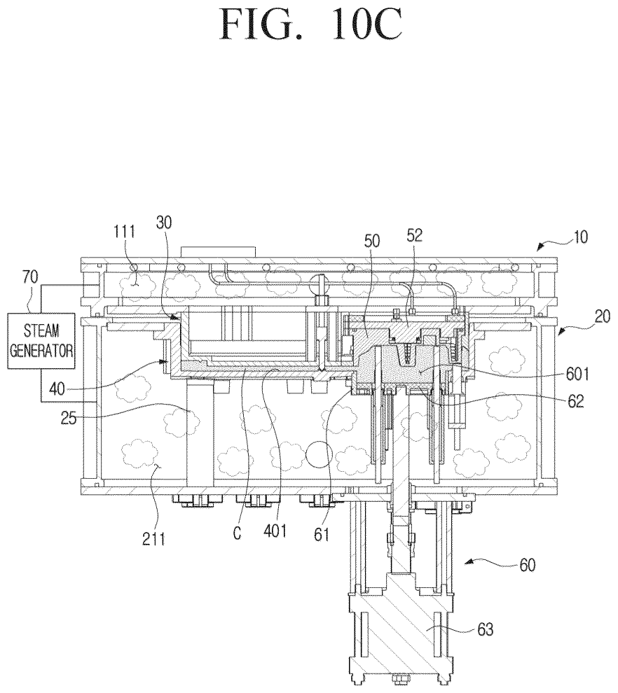

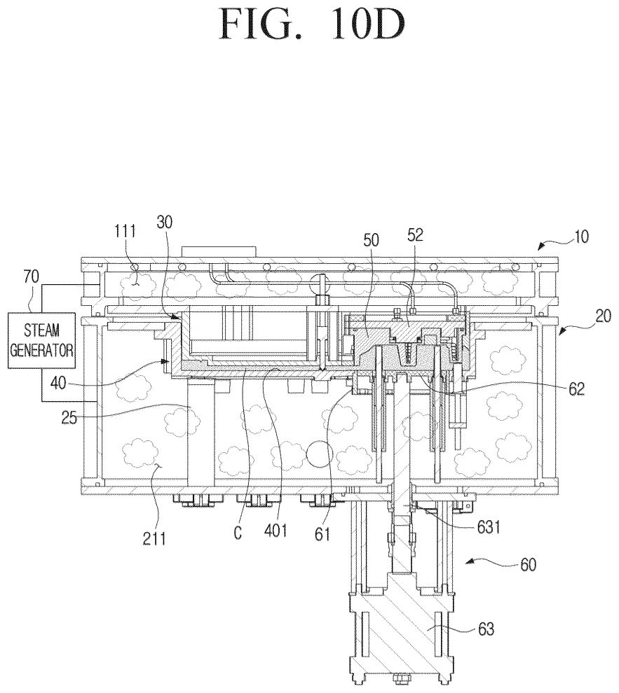

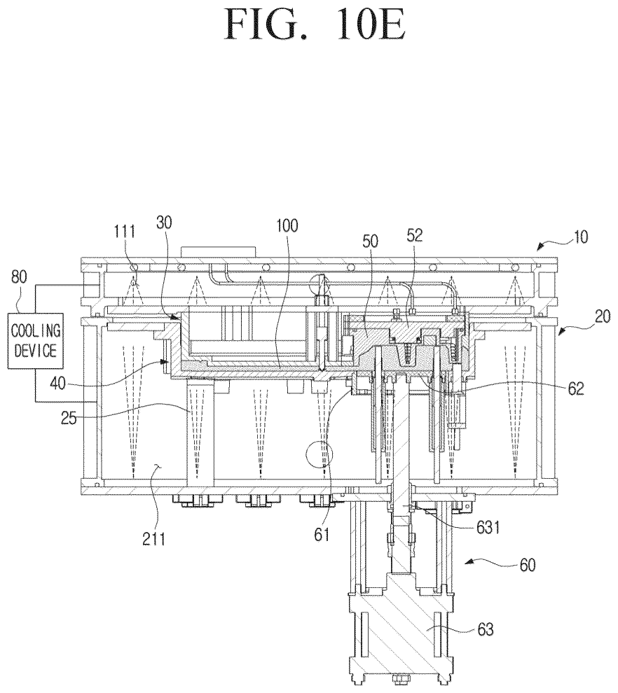

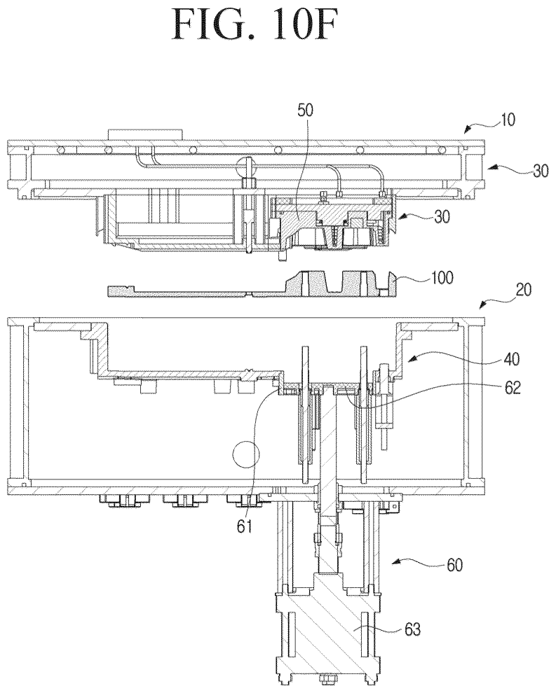

The lower mold 20 may include a lower core 40. The lower core 40 may form a cavity C (see FIG. 10D) corresponding to the EPS product 100 together with the upper core 30.

The lower core 40 may be formed concavely to form a space 41 into which the upper core 30 is inserted. The inner surface of the lower core 40 and the outer surface of the upper core 30 inserted into the lower core 40 may form the cavity C.

The lower core 40 may include a resin replenishment device 60. The resin replenishment device 60 may be provided on the lower surface 401 of the lower core 40. The resin replenishment device 60 may form a groove in which resin may be received on the lower surface of the lower core 40. In other words, the resin replenishment device 60 may form a replenishment resin space 601 that may receive replenishment resin required when molding the EPS product 100.

The replenishment resin space 601 of the resin replenishment device 60 may be arranged to face the heating core 50. Accordingly, the resin replenishment device 60 may replenish the insufficient amount of resin that occurs when the heating core 50 melts the resin to form the polystyrene layer 102. The size of the replenishment resin space 601 may be defined according to the volume of resin that becomes insufficient when forming the EPS product 100 by forming the polystyrene layer 102.

When the heating core 50 is heated by the heating source 52, the resin in contact with the heating core 50 may be melted to form a high-density polystyrene layer 102. In this case, the polystyrene layer 102 may have a higher density than the EPS layer forming the body 101.

When forming the polystyrene layer 102 and the EPS layer having the same volume, the amount of resin required to form the polystyrene layer 102 is greater than the amount of resin required to form the EPS layer. Therefore, in order to mold the EPS product 100 including the polystyrene layer 102 according to one or more embodiments of the disclosure, a greater amount of resin may be required compared to an EPS product without the polystyrene layer 102.

The EPS product 100 according to one or more embodiments of the disclosure may be formed by forming the body 101 and the polystyrene layer 102 in one process using the same resin, for example, EPS beads. Therefore, the EPS product 100 according to one or more embodiments of the disclosure including the polystyrene layer 102 may require a larger amount of EPS beads for molding compared to the EPS product without the polystyrene layer 102 with the same shape as the EPS product 100 of the disclosure.

The resin replenishment device 60 may be configured to replenish the resin used when forming the polystyrene layer 102 with the heating core 50 in this way.

As illustrated in FIG. 9, the lower core 40 may include two resin replenishment devices 60. The two resin replenishment devices 60 may be disposed at a certain distance apart from each other on the lower surface 401 of the lower core 40. The two resin replenishment devices 60 may be formed identically.

Because the two resin replenishment devices 60 are configured identically, a detailed description will be given of one resin replenishment device 60 below.

Referring to FIG. 5, FIG. 6, FIG. 7, FIG. 8, and FIG. 9, the resin replenishment device 60 may include an extension wall 61, a moving plate 62, and a moving device 63.

The extension wall 61 may extend downward from the lower surface 401 of the lower core 40 and form the replenishment resin space 601. The extension wall 61 may be formed in an approximately rectangular shape and may extend downward from the lower surface 401 of the lower core 40. Accordingly, the extension wall 61 may form a side surface of the replenishment resin space 601.

A bottom plate 611 may be disposed at the lower end of the extension wall 61. The bottom plate 611 may be formed to cover an approximately rectangular space formed by the extension wall 61.

The moving plate 62 may be disposed inside the extension wall 61 and form a lower surface of the replenishment resin space 601. The moving plate 62 may be disposed on the upper side of the bottom plate 611. Therefore, the moving plate 62 may be formed in an approximately rectangular shape corresponding to the inner space of the extension wall 61. The moving plate 62 may be disposed to move up and down along the extension wall 61.

The moving device 63 may be configured to move the moving plate 62 up and down. In other words, the moving device 63 may be configured to move the moving plate 62 in a linear reciprocating motion. Therefore, the moving plate 62 may be moved up and down with respect to the extension wall 61 by the moving device 63.

When the moving plate 62 is raised to the maximum, that is, when the moving plate 62 is located at the highest point, the upper surface of the moving plate 62 may coincide with the lower surface 401 of the lower core 40. When the moving plate 62 is lowered to the maximum, that is, when the moving plate 62 is located at the lowest point, the moving plate 62 may not go beyond the lower end of the extension wall 61. For example, as illustrated in FIG. 5, when the moving plate 62 is located at the lowest point, the lower surface of the moving plate 62 may be adjacent to or in contact with the bottom plate 611 of the extension wall 61.

The moving device 63 may be configured to reciprocate the moving plate 62 between the highest point and the lowest point. An actuator capable of linear motion may be used as the moving device 63. For example, the moving device 63 may be implemented as a cylinder.

The cylinder 63 may include a cylinder body and a rod 631. The rod 631 may be disposed to reciprocate linearly with respect to the cylinder body. The moving plate 62 may be connected to the leading end of the rod 631. A through hole through which the rod 631 may pass may be provided in the bottom plate 611 of the lower core 40. Therefore, when the rod 631 reciprocates linearly, the moving plate 62 may reciprocate linearly up and down with respect to the extension wall 61.

In order to enable the moving plate 62 to move up and down stably, a pair of guide shafts 632 may be disposed on the moving plate 62. The pair of guide shafts 632 may be inserted into a pair of guide blocks 633 disposed at the lower end of the extension wall 61, that is, on the lower surface of the bottom plate 611. Then, the pair of guide shafts 632 may slide along the pair of guide blocks 633.

Therefore, when the moving plate 62 moves up and down by the cylinder 63, the moving plate 62 may be supported by the pair of guide shafts 632 and the pair of guide blocks 633, so that the moving plate 62 may stably perform a linear reciprocating motion up and down.

The lower core 40 may be disposed on the lower plate 21. The lower core 40 may be disposed on the upper surface of the lower plate 21. The lower core 40 may be disposed to protrude into the interior of the lower plate 21.

The lower plate 21 may be provided with a resin supply passage 25 configured to supply resin, for example, EPS beads, into the space of the lower core 40. One end of the resin supply passage 25 may be connected to the bottom of the lower core 40, and the other end thereof may be connected to a resin supply device provided externally.

A space may be provided inside the lower plate 21. In other words, an inner space 211 may be provided between the outer surface of the lower plate 21 and the lower core 40. Steam for heating the lower core 40 may be supplied into the inner space 211 of the lower plate 21. In addition, coolant for cooling the lower core 40 may be supplied into the inner space 211 of the lower plate 21.

The upper mold 10 and the lower mold 20 may be connected to a steam generator 70 configured to generate high-temperature steam for heating the upper core 30 and the lower core 40.

The temperatures of the upper core 30 and the lower core 40 heated by the steam generated from the steam generator 70 may be lower than the temperature of the heating core 50 heated by the heating source 52. In other words, the temperature of the heating core 50 heated by the heating source 52 may be higher than the temperatures of the upper core 30 and the lower core 40 heated by the steam of the steam generator 70.

For example, the heating core 50 may be heated to a temperature range of about 100° C. to about 120° C., or at least 100° C. to 120° C.,. The upper core 30 and the lower core 40 may be heated to about 90° C., or at least to 90° C., by the steam of the steam generator 70.

The steam generator 70 may be provided apart from the upper mold 10 and the lower mold 20, and may be configured to generate high-temperature steam. The steam generator 70 may be connected to the upper mold 10 and the lower mold 20 and supply steam to the upper mold 10 and the lower mold 20. The upper core 30 and the lower core 40 may be heated by the steam supplied from the steam generator 70.

The steam generator 70 may be configured to supply high-temperature steam to the internal space 111 of the upper plate 11 and the inner space 211 of the lower plate 21. Then, the high-temperature steam introduced into the internal space 111 of the upper plate 11 may heat the upper core 30. In addition, the high-temperature steam introduced into the inner space 211 of the lower plate 21 may heat the lower core 40.

The upper mold 10 and the lower mold 20 may include a cooling device 80 configured to cool the upper core 30 and the lower core 40.

The cooling device 80 may be configured to cool the upper core 30 and the lower core 40. In other words, the cooling device 80 may be configured to cool the upper core 30 and the lower core 40 heated by the steam generator 70. The cooling device 80 may include a liquid spray device configured to spray a liquid that may cool the upper core 30 and the lower core 40. For example, the cooling device 80 may be implemented as a coolant spray device configured to spray coolant.

The coolant spray device 80 may be configured to spray coolant into the internal space 111 of the upper plate 11 and the inner space 211 of the lower plate 21. Then, the coolant sprayed into the internal space 111 of the upper plate 11 may cool the upper core 30. In addition, the coolant sprayed into the inner space 211 of the lower plate 21 may cool the lower core 40.

In such one or more embodiments, the coolant spray device is used as the cooling device 80. However, the cooling device 80 is not limited to the coolant spray device. Various types of cooling devices 80 may be used as long as they can cool the upper core 30 and the lower core 40.

In the above, the heating core 50 is provided in the upper core 30 and the resin replenishment device 60 is provided in the lower core 40. However, the disclosure is not limited thereto. As another example, the heating core 50 may be provided in the lower core 40 and the resin replenishment device 60 may be provided in the upper core 30.

The EPS product 100 according to one or more embodiments of the disclosure may be manufactured using the EPS product mold 1 having the above-described structure.

The method for manufacturing an EPS product using the EPS product mold 1 may include heating a heating core 50, moving an upper mold 10 to be adjacent to a lower mold 20 to form a resin filling space 411 with an upper core 30 of the upper mold 10 and a lower core 40 of the lower mold 20, filling resin into the resin filling space 411, moving the upper mold 10 so that the upper core 30 and the lower core 40 form a cavity C corresponding to an EPS product 100, operating a heating device 70 to heat the upper core 30 and the lower core 40, operating a resin replenishment device 60 to replenish resin into the cavity C, terminating heating of the heating core 50, terminating heating the heating device 70, operating a cooling device 80 to cool the upper core 30 and the lower core 40, moving the upper mold 10 away from the lower mold 20, and taking out the EPS product 100 from the lower core 40.

Hereinafter, a method for manufacturing an EPS product according to one or more embodiments of the disclosure will be described in detail with reference to FIG. 10A, FIG. 10B, FIG. 10C, FIG. 10D, FIG. 10E, and FIG. 10F.

First, as illustrated in FIG. 10A, an upper mold 10 and a lower mold 20 may be prepared in a spaced state.

FIG. 10A is a cross-sectional view illustrating an upper mold 10 and a lower mold 20 of an EPS product mold 1 according to one or more embodiments of the disclosure in a spaced state.

Referring to FIG. 10A, the upper coating drying region 204 is at a certain distance from the lower core 40, and the resin replenishment device 60 moves the moving plate 62 below the lower surface 401 of the lower core 40 to form a replenishment resin space 601.

In this state, the upper mold 10 may be lowered so that the upper core 30 is inserted into the space 41 of the lower core 40 as illustrated in FIG. 10B.

FIG. 10B is a cross-sectional view illustrating a state in which the upper mold 10 is lowered in FIG. 10A and an upper core 30 is inserted into a lower core 40 of the lower mold 20.

Referring to FIG. 10B, the upper core 30 covers the upper portion of the lower core 40, but is not completely inserted into the lower core 40. In other words, the upper core 30 and the lower core 40 may not form a cavity C corresponding to the EPS product 100. In this case, the space between the upper core 30 and the lower core 40 may form a resin filling space 411 having a volume larger than the volume of the cavity C.

At this time, the heating source 52 may operate to heat the heating core 50. The heating core 50 may begin heating before the upper mold 10 is lowered.

In addition, the resin E may be filled into the resin filling space 411 between the upper core 30 and the lower core 40. In other words, when the resin supply device operates, the resin E may be supplied through thee resin supply passage 25 provided in the lower plate 21 to fill the resin filling space 411 between the upper core 30 and the lower core 40. At this time, the resin E may be filled into the replenishment resin space 601 formed by the resin replenishment device 60. The resin E filled into the resin filling space 411 and the replenishment resin space 601 may be formed of EPS beads.

When the resin E is filled in the resin filling space 411 between the upper core 30 and the lower core 40, the resin E adjacent to the heating core 50 may begin to melt.

In the state of FIG. 10B, the upper mold 10 may be lowered further so that the upper core 30 is completely inserted into the lower core 40 as illustrated in FIG. 10C.

FIG. 10C is a cross-sectional view illustrating a state in which the upper core 30 of the upper mold 10 in FIG. 10B is completely inserted into the lower core 40 of the lower mold 20 to form a cavity C.

Referring to FIG. 10C, the upper core 30 and the lower core 40 may form the cavity C. In other words, the space between the upper core 30 and the lower core 40 may form the cavity C corresponding to the EPS product 100.

When the upper core 30 is completely inserted into the lower core 40, the heating device 70, i.e., the steam generator, may be operated. Then, steam may be supplied to the internal space 111 of the upper plate 11 and the inner space 211 of the lower plate 21 to heat the upper core 30 and the lower core 40.

When the upper core 30 and the lower core 40 are heated, the resin may be heated. When the resin is heated to a certain temperature, the resin may be foamed to form a body 101. For example, EPS beads may be foamed to form the body 101 made of EPS. At this time, the resin in contact with the heating core 50 may be melted to form a polystyrene layer 102. For example, the EPS beads in contact with the heating core 50 may be melted to form the polystyrene layer 102 having the high-density.

When the resin is melted by the heating core 50, there is not enough resin to fill the cavity C, so as illustrated in FIG. 10D, the moving plate 62 of the resin replenishment device 60 may be raised to raise the resin in the replenishment resin space 601. In other words, the moving plate 62 may be raised to supply the resin in the replenishment resin space 601 to the cavity C.

FIG. 10D is a cross-sectional view illustrating a state in which a resin replenishment device 60 is raised in FIG. 10C.

Referring to FIG. 10D, the moving plate 62 of the resin replenishment device 60 may be raised so that the upper surface of the moving plate 62 and the lower surface of the lower core 40 are aligned with each other. Then, as the resin is melted by the heating core 50 to form the polystyrene layer 102, the amount of resin that insufficient to fill the cavity C may be filled with the resin contained in the replenishment resin space 601 of the resin replenishment device 60.

In this case, because the moving plate 62 forming the lower surface of the replenishment resin space 601 moves upward by the moving device 63, a certain pressure may be applied to the resin in contact with the heating core 50. Accordingly, the structure of a body layer of the EPS product 100 corresponding to the area of the polystyrene layer 102 formed by the heating core 50 may become more dense.

After a certain period of time, the operation of the heating source 52 may be stopped to terminate the heating of the heating core 50. Then, the operation of the heating device 70 may be stopped to terminate the heating of the upper core 30 and the lower core 40.

After the operations of the heating source 52 and the heating device 70 are stopped, the cooling device 80 may be operated as illustrated in FIG. 10E.

FIG. 10E is a cross-sectional view illustrating a state in which the upper core 30 and the lower core 40 are cooled in FIG. 10D.

Referring to FIG. 10E, the cooling device 80 may operate to spray coolant toward the upper core 30 in the internal space 111 of the upper plate 11 and the lower core 40 in the inner space 211 of the lower plate 21. When the coolant is sprayed for a certain period of time, the upper core 30 and the lower core 40 may be cooled to a certain temperature.

When the cooling of the upper core 30 and the lower core 40 is completed, the upper mold 10 may be raised as illustrated in FIG. 10F.

FIG. 10F is a cross-sectional view illustrating a state in which the upper mold 10 is raised in FIG. 10E and an EPS product 100 is taken out.

Referring to FIG. 10F, the upper mold 10 may be raised so that the upper core 30 is positioned a certain distance above the lower core 40.

When the upper mold 10 moves upward a certain distance, the EPS product 100 located in the lower core 40 of the lower mold 20 may be taken out. The EPS product 100 may be taken out using an ejector provided in the lower core 40.

As described above, according to the method for manufacturing an EPS product according to one or more embodiments of the disclosure, the EPS product 100 having the body 101 including the polystyrene layer 102 and the EPS portion may be molded through a single process. In other words, the EPS portion and polystyrene layer 102 of the body 101 of the EPS product 100 may be formed simultaneously in a single process. Therefore, the manufacturing cost and manufacturing time of the EPS product 100 having the polystyrene layer 102 may be reduced.

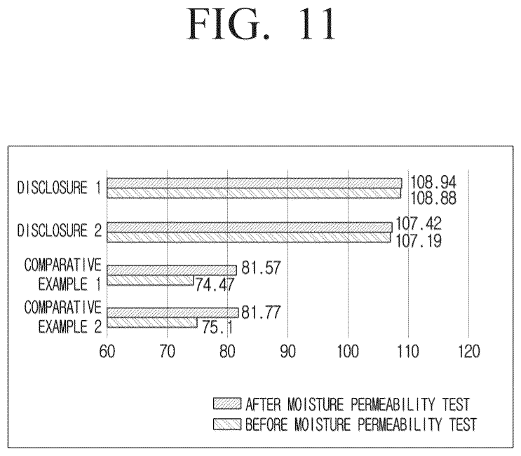

Hereinafter, a moisture penetration prevention effect of the polystyrene layer 102 of the EPS product 100 according to one or more embodiments of the disclosure will be described with reference to FIG. 11.

FIG. 11 is a graph comparing the moisture permeability of an EPS product 100 according to one or more embodiments of the disclosure and the moisture permeability of an EPS product 100 according to a comparative example.

The moisture permeability test measures the change in weight of the container. That is, it measures the amount of water absorbed by the container, i.e., the moisture permeability.

For the moisture permeability test, four open-top rectangular containers having the same volume were manufactured from EPS. Two containers corresponding to the disclosure have a polystyrene layer 102 formed on the inner surface of the rectangular container, like the EPS product 100 according to one or more embodiments of the disclosure. Two containers according to the comparative example do not have the polystyrene layer 102 formed on the inner surface of the rectangular container.

In FIG. 11, the disclosure 1 and the disclosure 2 show the results of performing the moisture permeability test with two containers corresponding to the disclosure. Comparative example 1 and comparative example 2 show the results of performing the moisture permeability test with two containers according to the comparative example. The horizontal axis represents the weight of the container, and the unit is gram (g).

Before moisture permeability test indicates the results of measuring the weight of the container corresponding to the disclosure and the weight of the container according to the comparative example.

After moisture permeability test indicates the results of filling the container corresponding to the disclosure and the container according to the comparative example with water, emptying the water after a certain period of time, for example, one week, and measuring the weight of the containers.

In the case of the container according to the disclosure 1, the weight of the container before moisture permeability test is 108.88 g, and the weight of the container after moisture permeability test is 108.94 g, so the amount of water permeated into the container is 0.06 g. Therefore, it can be seen that the amount of water absorbed by the container to which the polystyrene layer 102 of the disclosure is applied is very small.

In the case of the container according to the disclosure 2, the weight of the container before moisture permeability test is 107.19 g, and the weight of the container after moisture permeability test is 107.42 g, so the amount of water permeated into the container is 0.23 g. Therefore, it can be seen that the amount of water absorbed by the container to which the polystyrene layer 102 of the disclosure is applied is very small.

As can be seen from the disclosure 1 and the disclosure 2, water may hardly penetrate into the polystyrene layer 102.

In the case of the container according to the comparative example 1, the weight of the container before moisture permeability test is 74.47 g, and the weight of the container after moisture permeability test is 81.57 g, so the amount of water permeated into the container is 7.1 g. Therefore, it can be seen that the amount of water absorbed into the container is very large compared to the container to which the polystyrene layer 102 is applied.

In the case of the container according to the comparative example 2, the weight of the container before moisture permeability test is 75.1 g, and the weight of the container after moisture permeability test is 81.77 g, so the amount of water permeated into the container is 6.67 g. Therefore, it can be seen that the amount of water absorbed into the container is very large compared to the container to which the polystyrene layer 102 is applied.

As can be seen from the moisture permeability test results of FIG. 11, the EPS product 100 according to one or more embodiments of the disclosure includes the polystyrene layer 102, and thus may have a much greater moisture penetration prevention effect than the EPS product 100 without the polystyrene layer 102. In other words, the EPS product 100 according to one or more embodiments of the disclosure may have excellent waterproof properties.

Therefore, the EPS product 100 according to one or more embodiments of the disclosure may be used as a component of a cold air duct of a refrigerator.

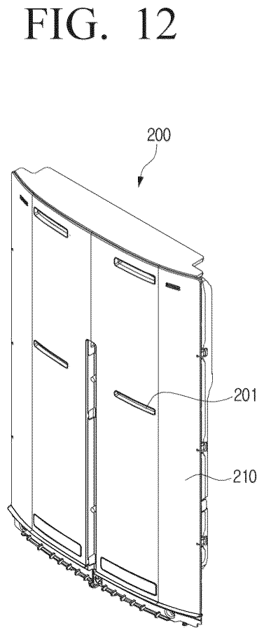

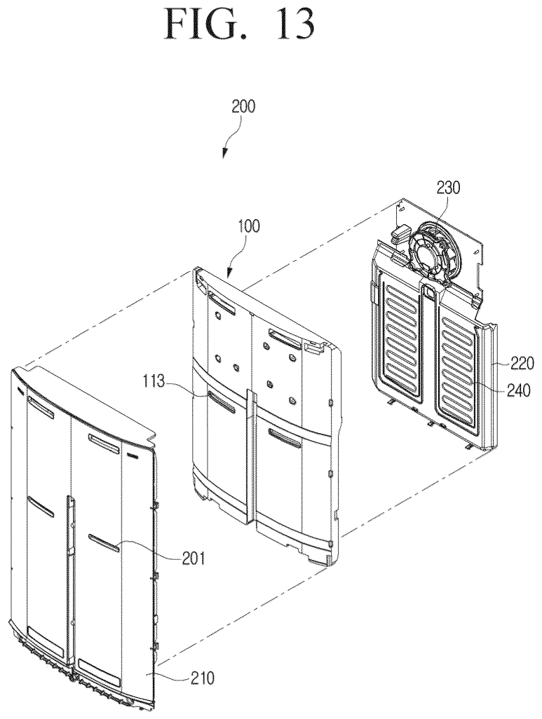

FIG. 12 is a perspective view illustrating a cold air duct 200 using an EPS product 100 according to one or more embodiments of the disclosure. FIG. 13 is an exploded perspective view illustrating the cold air duct 200 of FIG. 12.

Referring to FIG. 12 and FIG. 13, the cold air duct 200 may include an evaporator cover 100, an outer cover 210, an evaporator receiving part 220, and a fan 230.

The evaporator cover 100 may be implemented as the EPS product 100 according to one or more embodiments of the disclosure as illustrated in FIG. 1 and FIG. 2. The evaporator cover 100 may include a fan seat 110 in which the fan 230 is installed. The fan seat 110 may be formed with a polystyrene layer 102 to prevent moisture penetration.

The evaporator cover 100 may be provided with a plurality of holes 113 through which cold air is introduced and discharged. In the case of this embodiment, the evaporator cover 100 is provided with four holes 113.

The outer cover 210 may be connected with the evaporator cover 100 and may form the rear surface of the storage compartment of the refrigerator. The outer cover 210 may include a plurality of external holes 201 corresponding to the plurality of holes 113 of the evaporator cover 100. In this embodiment, the four external holes 201 may be provided in the outer cover 210.

When the outer cover 210 is connected with the evaporator cover 100, the plurality of external holes 201 and the plurality of holes 113 may form a plurality of inlets and outlets. In this embodiment, when the outer cover 210 is connected with the evaporator cover 100, four external holes 201 and four holes 113 are connected to form two inlets and two outlets. Therefore, cold air in the storage compartment may be introduced through two inlets and discharged through two outlets.

The evaporator receiving part 220 may be configured so that the evaporator 240 is installed. The evaporator cover 100 may be installed in front of the evaporator receiving part 220. Therefore, the evaporator receiving part 220 and the evaporator cover 100 may form a cold air path through which cold air may flow.

The fan 230 may be installed in the fan seat 110 of the evaporator cover 100. The fan 230 may be located on the upper side of the evaporator receiving part 220. When the fan 230 operates, air in the storage compartment may be introduced into the cold air path through two inlets, cooled as it passes through the evaporator 240, and become cold air. The cold air may be discharged to the storage compartment through two outlets.

Such cold air duct 200 may be installed at the rear side of the storage compartment 301 of the refrigerator 300 as illustrated in FIG. 14. The storage compartment 301 of the refrigerator 300 may be implemented as a refrigerating compartment or a freezer compartment.

FIG. 14 is a partial perspective view illustrating a refrigerator using an EPS product 100 according to one or more embodiments of the disclosure.

Referring to FIG. 14, the cold air duct 200 including the EPS product 100 according to one or more embodiments of the disclosure may be installed at the rear side of the storage compartment 301 of the refrigerator 300.

When the fan 230 (see FIG. 13 for example) of the cold air duct 200 operates, the air in the storage compartment 301 may be introduced into the inside of the cold air duct 200 through two of the four external holes 201 and become cold air while passing through the evaporator 240. The cold air may be discharged into the storage compartment 301 through the remaining two of the four external holes 201.

In other words, when the fan 230 operates, the air may be circulated through the storage compartment 301 and the cold air duct 200 to maintain the storage compartment 301 at a low temperature. At this time, the air containing moisture sucked into the cold air duct 200 by the fan 230 may collide with the fan seat 110 of the evaporator cover 100. However, the evaporator cover 100 according to one or more embodiments of the disclosure has the fan seat 110 formed of the polystyrene layer 102, so moisture may not penetrate into the fan seat 110.

In the above, the case where the EPS product 100 according to one or more embodiments of the disclosure is implemented as the evaporator cover 100 of the refrigerator 300 has been described as an example, but the disclosure is not limited thereto. The disclosure may be applied to all products manufactured from expanded polystyrene that require prevention of moisture permeability.

Although certain embodiments of the disclosure have been shown and described, it is understood by those skilled in the art that various changes may be made in form and detail without departing from the scope of the disclosure as defined by the appended claims and equivalents thereof.

What is claimed is:

1. An expanded polystyrene (EPS) product comprising:
an EPS body; and
a polystyrene layer on a portion of a surface of the EPS body,
wherein a density of the polystyrene layer is greater than a density of the EPS body, and
wherein both the EPS body and the polystyrene layer comprise EPS.

2. The EPS product of claim 1, wherein the EPS body is under the polystyrene layer, and
the polystyrene layer and the EPS body are formed together in a same mold.

3. The EPS product of claim 1, wherein a density of the EPS body is 0.03 to 0.05 of the density of the polystyrene layer.

4. The EPS product of claim 1, wherein a thickness of the polystyrene layer is less than a thickness of the EPS body.

5. An EPS product mold comprising:
an upper mold comprising an upper core;
a lower mold comprising a lower core configured to fit to the upper core and thereby form a cavity corresponding to an EPS product;
a heating core provided in the upper core and configured to form a polystyrene layer on the EPS product; and
a resin replenishment device provided at least partly in the lower core and configured to form a replenishment resin space in which replenishment resin is received within the cavity.

6. The EPS product mold of claim 5, wherein the resin replenishment device faces the heating core.

7. The EPS product mold of claim 6, wherein the resin replenishment device comprises:
an extension wall extending from the lower core and comprising a side surface of the replenishment resin space;
a moving plate installed on an inside of the extension wall and facing inside of the cavity, the moving plate comprising a lower surface of the replenishment resin space; and
a moving device configured to move the moving plate up and down with respect to the extension wall.

8. The EPS product mold of claim 7, wherein the moving device is further configured to move the moving plate with respect to the extension wall at least to a position at which an upper surface of the moving plate coincides with the lower surface of the lower core.

9. The EPS product mold of claim 5, wherein the heating core comprises an induction coil.

10. The EPS product mold of claim 5, further comprising a steam generator configured to supply steam heating the upper core and the lower core, and
wherein the upper mold and the lower mold are connected to the steam generator.

11. The EPS product mold of claim 10, wherein a temperature of the heating core is higher than temperatures of the upper core and the lower core heated by the steam.

12. The EPS product mold of claim 5, further comprising a cooling device configured to cool the upper core and the lower core.

13. A method for manufacturing an EPS product, the method comprising:
heating a heating core;
moving an upper mold to be adjacent to a lower mold to form a resin filling space by an upper core of the upper mold and a lower core of the lower mold;
filling resin into the resin filling space;
moving the upper mold so that the upper core and the lower core together form a cavity corresponding to the EPS product;
heating the upper core and the lower core by supplying steam to at least one of the upper mold or the lower mold;
operating a resin replenishment device to supply a resin into the cavity and replenish a molten volume of the resin;
terminating the heating of the heating core;
terminating the supplying of the steam;
operating a cooling device to cool the upper core and the lower core;
moving the upper mold away from the lower mold; and
taking out the EPS product from the lower core.

14. The method of claim 13, wherein at least some of the resin contacts the heating core and forms a polystyrene layer of the EPS product.

15. The method of claim 14, wherein a volume of the resin filling space corresponds to an amount of the resin forming the polystyrene layer.
